(19) United States
(12) Patent Application Publication
(10) Pub. No.: US 2011/0233118 A1
(43) Pub. Date: Sep. 29, 2011

(54) SPORTS BOTTLE DEVICE WITH FILTER ISOLATED FROM FILTERED FLUID

(76) Inventor: Steven D. Nelson, Buena Park, CA (US)

(21) Appl. No.: 12/749,245

(22) Filed: Mar. 29, 2010

(51) Int. Cl. B01D 29/92; B65D 1/04; B01D 35/153; B01D 35/02; B01D 29/88; C02F 1/00

(52) U.S. Cl. 210/117; 215/6; 210/236

(57) ABSTRACT

A sports bottle device including a pair of compartments forming filtered and unfiltered chambers, a filter in the unfiltered chamber and an isolation device isolating the filter from the filtered chamber.

### BACKGROUND

1. Field of the Invention

The field of the invention relates to sports bottles and particularly to sports bottles incorporating filters for filtering tap water and the like.

2. Description of the Prior Art

With the active healthy way of life subscribed to by many in society, a great demand exists for personal sports bottles for carrying a quantity of refreshing or energizing liquid for quick hydration during sporting activities such as running, bicycling, hiking, tennis, golf and the like. Typically, sports bottles are constructed of plastic, a material often not biodegradable and, with the relatively high consumption at today's rates, the landfills are fast filling with single use bottles.

It has long been recognized that the cost and inconvenience of accessing filtered water is a problem which can discourage consumption of sufficient quantities of fluids to adequately hydrate the athlete. an even overriding concern is that the one use bottles can contribute significantly to the rapid filling of landfills. Accordingly, there has long existed a need for a compact and convenient filtration device which would allow for use of readily available tap water which could be conveniently and inexpensively introduced and filtered allowing for numerous repeated use of the filtration body device.

The need for water purification was recognized long ago by inventors seeking to provide a filter which could be connected between the threaded necks of water bottles to thus allow for filtration of water through exhausted Zeolite filters for purifying and sterilization of the water. A device of this type is shown in U.S. Pat. No. 2,167,225 Van Eweyk. These devices are relatively cumbersome and impractical for personal use which often involves carrying on one's waste or on a bicycle frame or the like.

A common theme followed by many artisans has been the proposals of water bottles incorporating filters in the dispensing neck or the like so that a user can draw water from the bottle through the filter. It has also been proposed to design the walls of the bottles to flex inwardly under manual pressure to thereby allow for reduction of volume to reduce the volume to dither drive fluid through the filter or possibly to allow for the recovery of the compressed walls to draw a partial vacuum thus drawing fluid from an unfiltered compartment through a filter or the like. As will be appreciated, neither the partial vacuum created by oral application of suction to the release valve of a sports bottle or partial vacuum applied by recovery of compressed sidewall is sufficient to create any appreciable pressure drop to force any meaningful volume of flow through a filter to remove impurities.

Efforts to improve on these prior devices have led to the proposal that a bellows pump be mounted on top of a bottle having a side straw so that fluid can be pressurized downwardly through a filter into the bottle to thus be available for withdrawal through the side straw. A device of this is shown in U.S. Pat. No. 5,733,448 to Kaura. While satisfactory for producing some filtration, such devices are incapable of taking the normal form of a traditional sports bottle and, furthermore, typically leave the filter exposed to the drinkable fluid whereby the addition of any additives to the drinking water are exposed directly to the filter thus creating a risk of clogging and contamination of the filter.

A device incorporating a filter in the neck of a bottle for filtering as the wall of the bottle is compressed to squeeze the fluid from the bottle is shown in U.S. Pat. No. 6,468,435 to Hughes.

It has been proposed to provide a multi-stage water purification device including a lower compartment having a flexible wall which may be compressed and then released to draw a partial vacuum to thus draw unfiltered water downwardly from an overhead compartment through a multi-stage filter to be partially filtered and stored in the lower compartment so that upon subsequent compression of the flexible walls the partially filtered water will be driven upwardly through a one-way valve to pass through a second stage filter to a filtered water compartment ready to be discharged through a pull up valve. Such devices are relatively complicated, expensive to manufacture and rely on atmospheric pressure to control the rate of fluid flow through the first stage filter. A device of this type is shown in U.S. Pat. No. 7,585,409 to Bommi et al.

Until now artisans were faced with the dilemma of selecting between relatively cumbersome self-filtering sports bottles that were inconvenient to use and those to which the use was discouraged from adding additives because of filter clogging problems.

### SUMMARY OF THE INVENTION

The present invention includes a water bottle having a first and second sections separated by a intermediate isolation device from which a filter may be suspended to be disposed in the second section for filtering water from the second section to be expelled into the first section for dispensing through a release valve or nipple. The isolation device includes a one-way valve isolating the filtered water from going back into contact with the filter.

### BRIEF DESCRIPTION OF THE DRAWINGS

FIG. 1 is a perspective view of a combination sports bottle and filtering device of the present invention;

FIG. 2 is a view similar to FIG. 1 but depicting sections of the bottle separated from one another;

FIG. 3 is a vertical sectional view, in enlarged scale, taken along the line 3-3 of FIG. 1;

FIG. 4 is a exploded view, in enlarged scale, of the lower portion of the upper section and coupling ring exploded above the lower section;

FIGS. 5, 6, 7 and 8 are transverse sectional view taken along the respective lines 5-5, 6-6, 7-7 and 8-8 of FIG. 3;

FIG. 9 is a vertical sectional view, in enlarged scale, taken along the line 9-9 of FIG. 6; and

FIG. 10 is a vertical sectional view similar to FIG. 9 but showing the bottom section decoupled from an isolation and coupling device.

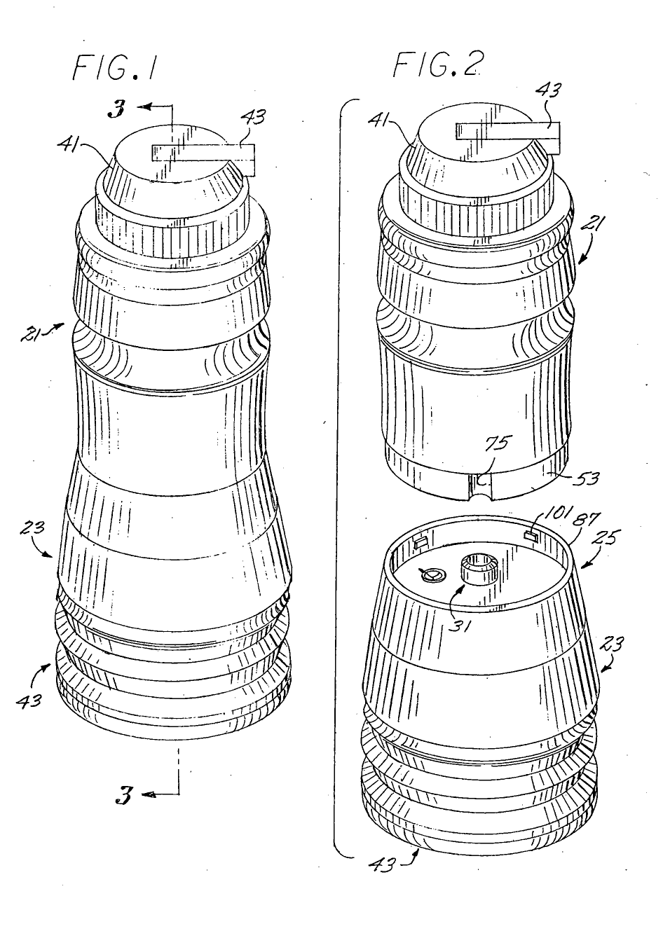

### DETAILED DESCRIPTION OF THE PREFERRED EMBODIMENTS

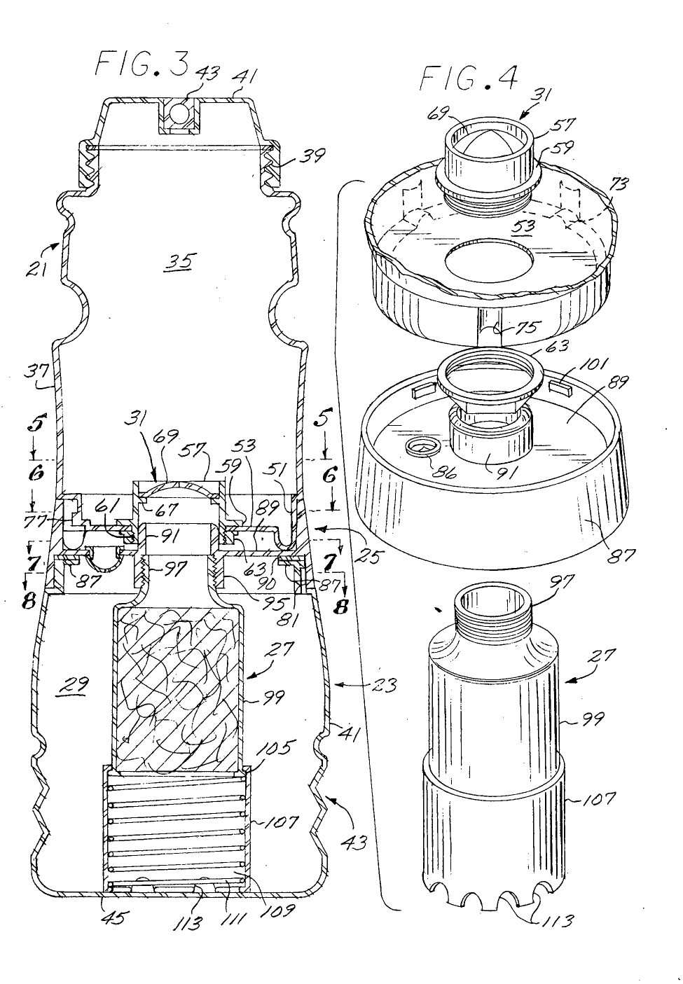

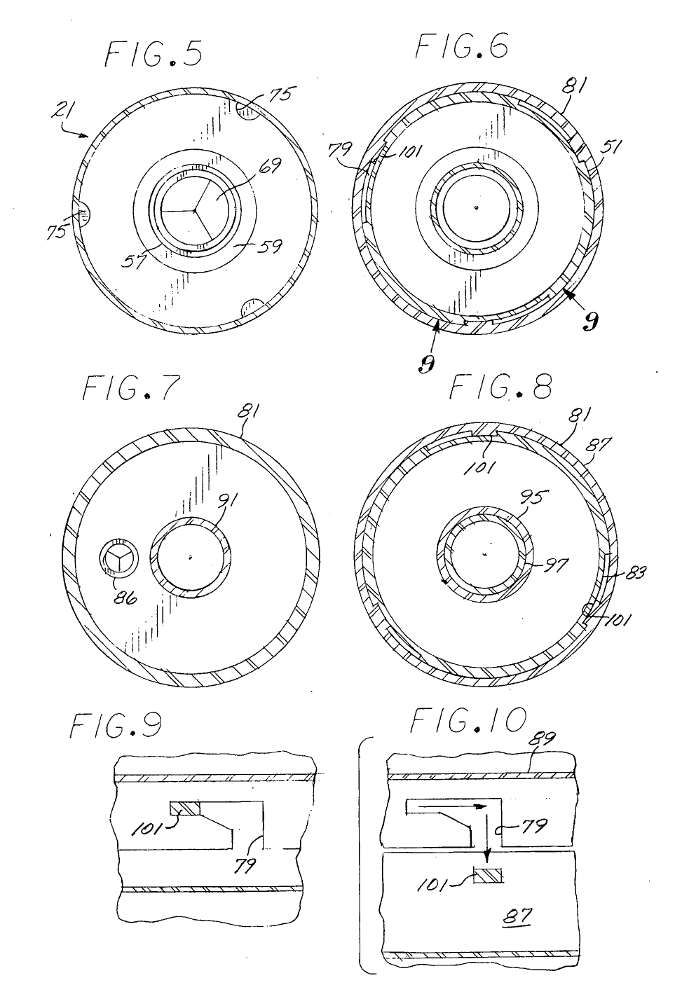

Referring to FIGS. 1 and 3, the personal water bottle device of the present invention includes, generally, an upper bottle section 21 coupled to a lower unfiltered bottle section 23 by means of an isolating and coupling device 25. The isolating and coupling device 25 suspends a filter device 27 in the chamber 29 formed by the bottle section 23 for flow of liquid upwardly there through upon application of pump pressure through to flow through a one-way check valve 31 to thus isolate the filtered water from the unfiltered water and from the filter.

Athletes, when exposed to competitive or other strenuous activity are encouraged to consume plentiful quantities of fluid and often prefer to add energy supplements or other additives to the liquid to enhance their performance. Thus, there exists a demand for a personal filtration water bottle device which is efficient to receive tap water and the like for filtration and which might be mixed with different types of additives and readily available for dispensing to hydrate the athlete. It is this objective to which the present invention is directed.

The bottle device of the present invention may be manufactured in separate upper and lower sections, the lower section 23 being configured for receipt of the filter device 27 and to facilitate a pump, while the upper section 21 acts as a storage chamber 35 for storing filtered fluid and the like. The bottle may be manufactured from any one of a number of different plastics such as high density polyethylene, polypropylene, poly vinyl fluoride, polytetrafluroethylene, or any other material well-known to those working in the art.

The upper, unfiltered bottle section 21 includes a sculptured peripheral wall 37 narrowed at its upper extremity to form an externally threaded neck 39 which receives an internally threaded cap 41 having a sealing spout 43 pivotally mounted thereon.

The lower, unfiltered section 23 includes a flexible peripheral wall 41 which may be configured with flexible annular bevels 43 to allow for the bottom wall 45 to be compressed upwardly a selected distance from the position shown in FIG. 3 to reduce the internal volume and act as a pump.

The bottom wall 51 of the upper bottle section 21 is rolled back on itself about the outer periphery to form an annular fold about an annular disk 53 formed centrally with a through bore 55 which receives the lower extremity of a stub tube 57 configured with an upstanding nipple. The stub tube 57 is formed medially with a radially projecting mounting flange 59 and projects downwardly there from through the bore 55 and is externally threaded with threads 61 for receipt of a hex nut 63 to fasten the stub tube in place. The stub tube is formed internally with an annular mounting flange 67 which mounts a duck bill valve 69 for flow of fluid upwardly there through but checking against flow downwardly there through.

The bottom wall is formed about its periphery with downwardly and outwardly opening breather channels 73 and 75 for introducing atmospheric air under the wall to the top of the bottom section 23. The wall is formed in its periphery with a plurality of circumferentially spaced, radially outwardly opening bayonet style notches 79 to form a screw thread connection with the coupling and isolation device 25.

The upper portion of the bottom bottle section 23 is configured with a reduced in diameter neck 81 which is also formed with radially outwardly opening bayonet style coupling notches 83 spaced about the periphery thereof. The neck is configured at its upper edge with a radially inturned annular sealing ring 87.

The coupling and isolation device 25 includes a cylindrical peripheral skirt 87 circumscribing a medial, annular horizontal wall 89 which is configured centrally with a vertical boss having at its upper extremity an upstanding nipple 91 sized and configured to be slip fit into sealing engagement with the interior of the bottom extremity of the stub tube 57 and formed on its lower extremity with a tubular boss 95 disposed under the wall 89 and internally threaded for screwable connection with the exteriorly threaded neck 97 of the pump housing 99 of the filter device 27.

The skirt 87 is configured on its interior with annular teeth 101 spaced about the periphery thereof for selective engagement with the respective bayonet notches 79 and 83.

The filter device 27 is preferably configured with the cylindrical housing 99 incorporating on its lower extremity a radially outturned flange 105 over which is telescoped a tubular pump housing 107 configured interiorly with a pump chamber 109 which receives a coil compression spring 109. The lower extremity of the housing 107 is formed with radially outwardly opening semi-circular apertures 113 forming fluid inlets from the chamber 29.

The filter device 27 includes a media 100 which may take any form for effectively filtering tap water such as that disclosed in U.S. Pat. No. 6,468,435 or 7,585,409. In one embodiment I have selected an Ionic Adsorption Micron Filter.

The filter device 27 is configured with a length sufficient to cause the bottom extremity of the pump housing 107 to abut the bottom wall 45 of the bottom bottle section 23 to be reciprocated by compression of the wall 45 upwardly and release to be driven downwardly by the spring 111 to essentially act as a snorkel to draw in a supply of tap water.

As will be appreciated, the pump device may take many different forms and in some embodiments will incorporate a radially inwardly compressible walls for the bottle section 23 and a tubular snorkel extending down from the filter device 27 such that compression of such side walls may be compressed to pressurize the chamber 29 and drive water up through the snorkel and through the filter. In other embodiments, the pump housing 107 is formed at its lower extremity with the apertures sized to have a composite cross sectional flow which will throttle flow radially outwardly there through when the housing is driven rapidly outwardly, to thus raise the pressure in the chamber 109 to drive water in that chamber upwardly through the filter.

Mounted eccentrically in the wall 89 is a one-way breather valve 86 which is in fluid communication with the respective breather channels 73 and 75 for selective introduction of air into the unfiltered liquid chamber 29. In some embodiments, the device of the present invention will incorporate the bleeder orifice in place of the one-way valve 86 to provide for slow bleeding in of atmospheric air but sufficiently small to resist venting when the venting at the same rate the volume chamber 29 is reduced upon compression of the bottom wall 45.

Interposed between the bottom side of the wall 89 and flange 87 is a annular fiber seal ring 90.

It will be appreciated that in some instances, the bottle and filtration device of the present invention may be constructed as a single unit with the bottom bottle section 23 incorporating a side inlet for introduction of tap water.

In operation of the sports bottle of the present invention, an athlete can unscrew the bottom bottle section 23 from the coupling device 25 for tap water to be introduced downwardly through the nipple 91 to flow downwardly through the filter device 27 and out the apertures 113 to fill the lower bottle section 23 with, for instance 20 ounces of water. Once the lower bottle section 23 is filled, the bottle section may be screwed back onto the coupling device 25 to compress the housing flange 87 against the seal 90 to seal the fluid against leakage. In the preferred embodiment, the upper and lower bottle sections 21 and 23 are formed with a volume of about 20 fluid ounces. It will be appreciated that as the lower chamber 29 fills, water will flow radially inwardly through the apertures 113 into the pump chamber 109 and snorkel up into the filter media.

With the bottle device upright, the athlete may then press the bottom wall 45 axially upwardly to collapse the bellows 43 thus reducing the volume of the chamber 29 and currently driving the pump housing 107 upwardly to thereby cooperate with the filter housing to also, in piston-like fashion reduce the volume of the pump chamber 109 thereby cooperating to cooperate in driving a volume of unfiltered water upwardly through the filter and upwardly out the nipple 91 to pass through the one-way valve 69 into the chamber 35. This procedure may be repeated two or three times to totally evacuate the fluid from the chamber 29, it being appreciated that between each pump the return spring 109 will return the bottom wall 45 to its lower most position as shown in FIG. 3 to again draw a volume of atmospheric air in through the valve 86 from the channels 75 and 73 sufficient to displace the liquid that has been displaced upwardly into the upper chamber 35. As will be appreciated by those in the art, the pump effect can be produced by many different pumping arrangements, including a piston pump by itself or other forms of flexible chamber walls which might be compressed to reduce the volume in the chamber 29.

If desirable, the bottle section 23 may again be separated from the section 21 and a new supply of tap water e introduced into the lower chamber 29 and the lower bottle section 23 recoupled to the coupling device 25 to thereby provide the athlete with approximately 20 ounces of filtered water in chamber 35 and 20 ounces of unfiltered water in the chamber 29 ready to be pumped through the filter device 27 when the quantity of filtered water has been depleted.

It will be appreciated that the filter device 27 will have long service life, maybe upwards of 1000 filtrations, thus saving the environment from accommodating disposal of some 1000 or so separate sports bottles. When the filter device reaches the end of its service life, with the bottle section 23 separated, the device may be unscrewed from the boss 95 and replaced with a new filter.

It will be appreciated that the device of the present invention has particular application for baby formulas and the like such that the parent will be able to gather water for mixing with the babies formula directly from a readily available tap thus eliminating the necessity of carrying numerous different bottles when traveling away from home.

From the foregoing it will be appreciated that the combination sports bottle and filter device provides a convenient and economical means for storage and filtration of tap water to maintain the filtered water separate from the unfiltered water and serves to isolate the filter device 27 so that additives added to the filtered water in chamber 35 continue to be isolated from the filter 27 to thus prevent clogging the pours of the filter device.

I claim:

1. A combination sports bottle and fluid storage container device comprising:
a bottle having top and bottom walls, the bottom wall including and inlet;
a fluid storage container adjacent the bottom wall and formed with a chamber for storing tap water;
a filter device disposed in the storage container, including an outlet coupled to the inlet, for receiving fluid from the container and flowing it through the outlet into the bottle;
a check valve for restricting fluid flow to flow only from the container into the bottle;
the chamber including a pump operable to pump fluid from the chamber, through the filter device, out the outlet and into the bottle.

2. The combination sports bottle and fluid storage container device as set forth in claim 1 that includes:
a mounting ring interposed between the container and bottle and mounting the filter device.

3. The combination sports bottle and fluid storage container device in claim 1 wherein:
the filter device includes an elongated filter element including one end formed with the outlet and having an opposite end defining a free end;
an elongated barrel having one end received slidably on the free end and formed with a pump chamber for receiving a charge of fluid from the container and operable upon sliding onto the filter element toward the outlet to pump the charge of fluid through the filter element into the bottle;
a driver for driving the barrel toward the outlet.

4. The combination sports bottle and fluid storage container device in claim 3 wherein:
a compression spring constrained in the pump chamber.

5. The combination sports bottle and fluid storage container device in claim 3 wherein:
the container is constructed with flexible side walls and a container bottom wall abutted against the housing for, upon the container bottom wall being driven against the housing, drive the housing slidably onto the filter.

6. The combination sports bottle and fluid storage container device in claim 1 wherein:
the container includes a bleeder for bleeding atmospheric air into the chamber

7. The combination sports bottle and fluid storage container device in claim 1 that includes:
a coupling ring device including an intermediate wall interposed between the container and bottle, and a peripheral skirt surrounding adjacent ends of the container and bottle and removably coupled to the bottle and container.

8. Combination sports bottle and fluid storage container device of claim 1 wherein:
the fluid storage container includes a peripheral wall formed with bellows for manual compression of the storage container to compress the bellows and force water from the chamber through the filter into the bottle.

9. A filtering sports bottle device comprising:
a bottle configured with longitudinally disposed filtered and unfiltered chambers;
the bottle including a filtered liquid outlet in the filtered chamber;
a filter device disposed in the unfiltered chamber, including a filter inlet and filter outlet;
an isolation device interposed between the chambers, mounting the outlet of the filter, and including a one way valve for flowing liquid from the filter outlet into the filtered chamber; and
a pump device in the unfiltered chamber for pumping fluid from the unfiltered chamber into the filter inlet, through the filter device and out the one way valve.

10. A filtering sports bottle device of claim 9 wherein:
the pump device include a flexible wall in the bottle forming the unfiltered chamber for compression to generate pressure in the unfiltered chamber.

11. A filtering sports bottle device claim 9 wherein:
the pump device includes a piston pump in communication with the inlet to the filter.

12. A filtering sports bottle device claim 10 wherein:
the pump device includes a piston pump connected with the inlet to the filter.

13. A filtering sports bottle device claim 9 wherein:
the bottle is configured with discrete upper and lower bottle sections forming the respective filtered and unfiltered chambers; and
the isolation device includes a coupling device for removably coupling the upper and lower bottle sections together.

14. A filtering sports bottle device is set forth in claim 9 wherein:
the unfiltered chamber is formed with a peripheral wall configured with flexible bellows for manual compression to reduce the volume of the unfiltered chamber and force liquid from such unfiltered chamber through the filter.

15. The filtering sports bottle device of claim 9 wherein:
the isolation device includes a vent valve for introducing air into the unfiltered chamber.

16. The filtering sports bottle device of claim 9 wherein:
the filter device is formed with a tubular filter housing and includes;
a pump housing received slidably over the filter housing and formed with a pump chamber;
a compression coil spring received in the pump chamber for biasing the pump housing to a distended position, the pump housing being slidable on the filter housing to compress the coil spring and reduce the volume of the pump chamber to drive fluid from such pump chamber through the filter and out the filter outlet.

17. A filter sports bottle device comprising:
an elongated bottle device configured with longitudinally disposed filtered and unfiltered chambers;
a filter device disposed in the unfiltered chamber and including a filter housing;
a pump housing received slidably over the filter housing and configured with a pump chamber and having a remote end;
a coil compression spring received in the pump housing and urging the remote end to a distended position, the pump housing further being formed with through flow passages for introduction of fluid from the unfiltered chamber to the pump chamber;
the filtered chamber being formed with peripheral walls and a bottom wall, the peripheral walls being configured with compressible flexible bellows to accommodate the bottom wall being pressed against the remote end of the pump housing to concurrently reduce the volume of the unfiltered chamber and the volume of the pump chamber to cooperate in driving fluid from such pump chamber through the filter and out the filter outlet;
the bottle section including a bottom wall formed with a centrally disposed through tubular stub;
a one way valve mounted in the tubular stub for flow of fluid from the unfiltered chamber to the filtered chamber;
a coupling device interposed between the filtered and unfiltered bottle sections and including a peripheral skirt formed with interior screw thread elements for threadably screwing unto the respective filtered bottle sections and unfiltered bottle sections to couple the respective sections together, the coupling device including a transverse wall mounting a centrally disposed nipple received slidably in sealing engagement with the bottom extremity of the stub tube and itself formed on its bottom extremity with a coupler for coupling with the outlet of the filter.

18. A filter device comprising:
a filter including and elongated filter housing:
a pump housing received slidably on one end of the housing;
a biasing device biasing the pump housing away from the filter housing.

19. The filter device of claim 18 for use with a sports bottle and wherein:
the sports bottle includes a storage compartment mounting the filter device and is further formed with a flexible side wall and an end driving wall, the flexible side wall being flexible for manual contact with the driving wall to drive the driving wall against the pump housing to side the pump housing on the filter housing.
